(19) United States
(12) Patent Application Publication
(10) Pub. No.: US 2013/0068609 A1
(43) Pub. Date: Mar. 21, 2013

(54) Dividing Wall Column for Alpha-Methylstyrene and Cumene Distillation

(71) Applicant: Kellogg Brown & Root LLC, Houston, TX (US)

(72) Inventors: Manish Bhargava, Katy, TX (US); Eric Wing-Tak Wong, Houseton, TX (US); Theodor R. Wilks, Sugar Land, TX (US)

(73) Assignee: Kellogg Brown & Root LLC, Houston, TX (US)

(21) Appl. No.: 13/622,171

(22) Filed: Sep. 18, 2012

Related U.S. Application Data
(60) Provisional application No. 61/536,517, filed on Sep. 19, 2011.
(60) Provisional application No. 61/536,529, filed on Sep. 19, 2011.

(51) Int. Cl. B01D 3/14

(52) U.S. Cl. 203/87; 202/158

(57) ABSTRACT

Methods and systems for fractionating a crude alpha-methylstyrene (AMS) feed using one or more dividing wall columns are provided. The method can include introducing a crude AMS to a fractionation column, wherein the fractionation column contains a dividing wall disposed at least partially within the fractionation column such that an internal volume of the fractionation column is divided into at least a pre-fractionation section and a main fractionation section. The crude AMS can be introduced to the pre-fractionation section of the fractionation column. A light hydrocarbon can be withdrawn from the fractionation column at or proximal a first end thereof, a side-stream can be withdrawn from the main fractionation section of the fractionation column, and a heavy hydrocarbon can be withdrawn from the fractionation column at or proximal the second end thereof.

### CROSS-REFERENCE TO RELATED APPLICATIONS

This application claims priority to U.S. Provisional Patent Applications having Ser. Nos. 61/536517 and 61/536529, both filed on Sep. 19, 2011, which are both incorporated by reference herein.

### BACKGROUND

1. Field

Embodiments described herein generally relate to systems and methods for separating hydrocarbons using one or more dividing wall columns. More particularly, such embodiments relate to systems and methods for separating alpha-methylstyrene (AMS) and cumene in a dividing wall column.

2. Description of the Related Art

Phenol is produced in various processes, the most common of which is known variously as the Hock Process, the Hock and Lang Process, or the cumene-to-phenol process, among others. This process begins with the oxidation of cumene (isopropyl benzene) to form cumene hydroperoxide (CHP). The CHP is then cleaved in the presence of an acid catalyst to form phenol and acetone. The phenol and acetone stream is subsequently neutralized in a salt solution and thereafter fractionated to recover the end-product phenol and a useful by-product acetone.

During the oxidation stage, however, several by-products are formed, including dimethyl benzyl alcohol (DMBA). The DMBA is dehydrated in the cleavage unit to produce AMS. The AMS is removed during acetone fractionation, e.g., in an acetone distillation column, as a crude AMS. The crude AMS can be purified, e.g., by distillation, and hydrogenated to produce cumene, which can be recycled back to the oxidation unit to increase the efficiency of the overall process.

AMS purification systems can include a dual fractionation column system, i.e., an AMS topping column and an AMS tailing column, or a single fractionation column with a side-draw. In the dual fractionation column system, the AMS topping column receives the crude AMS from the acetone distillation column, and light impurities are purged as an overhead or top product. The topping column bottoms is fed to the AMS tailing column for further distillation of the bottoms to produce an overhead or top product that includes a mixture of cumene and AMS, and a bottoms product that includes heavier compounds. This two-column system generally provides sufficient efficiency and purification ability; however, it has a high capital investment cost because of the necessity of two columns and associated heat exchangers, drums, pumps, etc.

Accordingly, single-column AMS distillation units with a side-draw have been implemented, but with limited success. In such systems, the AMS/cumene stream (analogous to the overhead stream in the AMS tailing column, above) is taken out as a side-stream. Although this single-column system has the advantage of a lower capital investment, the resulting AMS/cumene stream is of reduced purity. Further, even at high reboiler duty, the single-column system generally cannot achieve the same purity level as the two-column system.

There is a need, therefore, for improved systems and methods for separating alpha-methylstyrene (AMS) and cumene.

### BRIEF DESCRIPTION OF THE DRAWINGS

FIG. 1 depicts an illustrative system for fractionating crude AMS in a cumene-to-phenol system, according to one or more embodiments described.

FIG. 2 depicts an illustrative system for producing phenol, according to one or more embodiments described.

### DETAILED DESCRIPTION

Methods and systems for fractionating a crude alpha-methylstyrene (AMS) feed using one or more dividing wall columns are provided. The method can include introducing a crude AMS to a fractionation column. The fractionation column can include a dividing wall disposed at least partially within the fractionation column such that an internal volume of the fractionation column is divided into at least a pre-fractionation section and a main fractionation section. The pre-fractionation section and the main fractionation section can be in fluid communication with one another via a rectification section, a stripping section, or both. The rectification section can be defined between a first end of the fractionation column and a first end of the dividing wall. The stripping section can be defined between a second end of the fractionation column and a second end of the dividing wall. The crude AMS can be introduced to the pre-fractionation section of the fractionation column. A light hydrocarbon can be withdrawn from the fractionation column at or proximal the first end thereof A side-stream can be withdrawn from the main fractionation section of the fractionation column. A heavy hydrocarbon can be withdrawn from the fractionation column at or proximal the second end thereof.

As used herein, the terms “fractionation column” and “column” refer to any system, device, or combination of systems and/or devices suitable for the separation of a mixture containing two or more components having differing boiling points. Such fractionation columns or columns can include, but are not limited to, dividing wall columns, scrub columns, distillation columns, rectification columns, and stripping columns. As used herein, the term “dividing wall column” refers to any column having a dividing wall. As used herein, the term “dividing wall” refers to any partition disposed at least partially within an interior of a column to provide at least a first fractionation zone on one side of the dividing wall and a second fractionation zone on the other side of the dividing wall. The dividing wall can be either segmented or continuous. The dividing wall can be parallel or non-parallel relative to a longitudinal axis of the column. The first fractionation zone and the second fractionation zone can have the same or different cross-sectional areas and/or volumes. The column can have a circular cross-section and the dividing wall can positioned or disposed within the column to provide the first fractionation zone and the second fractionation zone having equal or un-equal cross-sectional areas with respect to one another. The dividing wall can extend completely or only partially from one side of the dividing wall column to the other side of the dividing wall column.

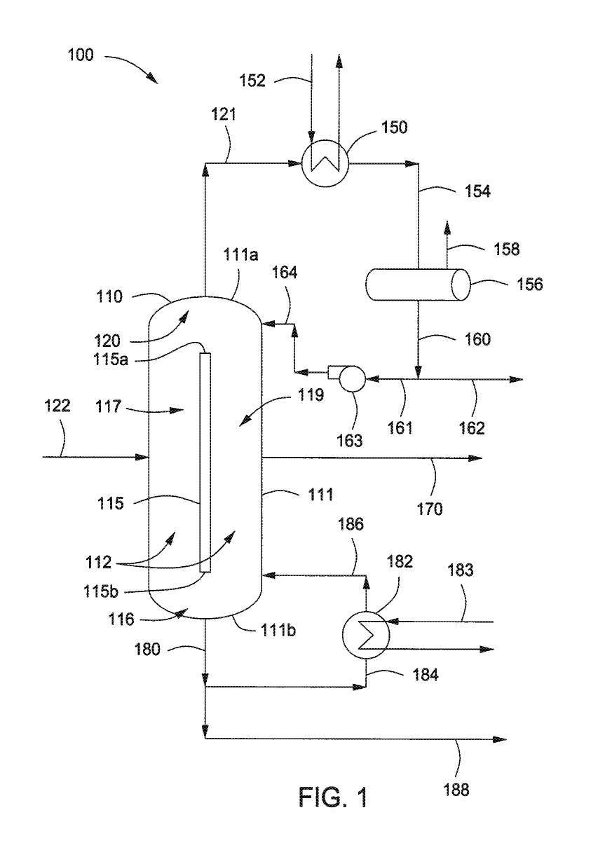

FIG. 1 depicts an illustrative system 100 for fractionating crude AMS, according to one or more embodiments. The system 100 can include one or more fractionation columns 110. The fractionation column 110 can include a shell or housing 111 disposed at any angle, in any configuration, and/or having any length to diameter (L/D) ratio. For clarity and ease of description, the fractionation column 110 will be further described with reference to a vertical, cylindrical, fractionation column 110 having an L/D ratio of greater than 1.

The shell or housing 111 of the fractionation column 110 can include two or more sections or volumes therein. For example, the fractionation column 110 can include a fractionation section 112, a rectification section 120, and a stripping section 116. The fractionation section 112 can be defined between the rectification section 120 and the stripping section 116. The rectification section 120 can be defined at or proximal to a first or “top” end 111a of the fractionation column 110. The stripping section 116 can be defined at or proximate to a second or “bottom” end 111b of the fractionation column 110.

The fractionation column 110 can also include one or more dividing walls (one is shown 115) at least partially positioned, located, or otherwise disposed at least partially therein. The dividing wall 115 can partition, separate, or otherwise divide the fractionation section 112 into two or more sections. For example, the dividing wall 115 can separate the fractionation section 112 into a first or “pre-fractionation” section 117 and a second or “main fractionation” section 119. The pre-fractionation section 117 and main fractionation section 119 can be in fluid communication with each other via the rectification section 120 and/or the stripping section 116, such that, in at least one example, the four sections 116, 117, 119, and 120 can be in fluid communication with one another. The rectification section 120 can be defined in the region between the first end 111a of the fractionation column 110 and a first or “top” end 115a of the dividing wall 115. The stripping section 116 can be defined in the region between the second end 111b of the fractionation column 110 and a second or “bottom” end 115b of the dividing wall 115.

The dividing wall 115 can be disposed within the fractionation section 112 such that the pre-fractionation section 117 and the main fractionation section 119 are of equal or unequal cross-sectional area. For example, the dividing wall 115 can bisect the cross-section of the fractionation section 112 such that the pre-fractionation section 117 and the main fractionation section 119 are of equal cross-sectional area. The dividing wall 115 can be a continuous or a segmented wall, baffle, divider, or other structure. The dividing wall 115 can he non-insulated, partially insulated, or completely insulated. The dividing wall 115 can be generally parallel and/or aligned with a longitudinal axis of the fractionating column 110, or can also be positioned at any desired angle with respect to the longitudinal axis of the fractionating column 110.

The pre-fractionation section 117 and the main fractionation section 119 can be empty, partially tilled, or completely filled with one or more fill materials (not shown). Illustrative fill materials can include, but are not limited to, trays, packing, or combinations thereof. The fill material can improve mass transfer and/or separation of a multi-component fluid. The fill material and/or the fill pattern in the pre-fractionation section 117 and the main fractionation section 119 can be the same or different. For example, the fill material in the pre-fractionation section 117 can include one or more structured and/or random packed materials while the fill material in the main fractionation section 119 can include one or more trays. Two or more types of fill material can be disposed within the pre-fractionation section 117 and/or the main fractionation section 119. For example, the pre-fractionation section 117 can contain random dumped packing beneath a feed introduction line or column inlet 122 and one or more trays above the column inlet 122.

As used herein, the term “trays” can include, but is not limited to, one or more types of trays that can improve the contact between gas and liquid phases within the fractionation column 110. Illustrative trays can include, but are not limited to perforated trays, sieve trays, bubble cap trays, floating valve trays, fixed valve trays, tunnel trays, cartridge trays, dual flow trays, baffle trays, shower deck trays, disc and donut trays, orbit trays, horse shoe trays, cartridge trays, snap-in valve trays, chimney trays, slit trays, or any combination thereof

As used herein, the term “packing material” can include, but is not limited one or more types of structured and/or random shaped material disposed within the fractionation column 110. The packing material can increase the effective surface area within the fractionation column 110, which can improve the mass transfer between liquid and gas phases within the fractionation column 110. The packing material can be made of any suitable material, for example metals, non-metals, polymers, ceramics, glasses, or any combination thereof. Illustrative examples of commercially available random packing material can include but are not limited to, IMTP®, INTALOX® ULTRA™, Raschig rings, A-Pak rings, saddle rings, Nutter Rings™, I-Rings™, C-Rings™, P-Rings™, R-Rings™, or any combination thereof. Illustrative examples of commercially available structured packing can include, but are not limited to, structured packing, corrugated sheets, crimped sheets, gauzes, grids, wire mesh, monolith honeycomb structures, or any combination thereof. For example, suitable structured packing can include but is not limited to FLEXIPAC®, FLEXIPAC® HC®, INTERLOX®, Montz-Pak, Mellapak™, MellapakPlus™, GT-PAK™, GT-OPTIM™ PAK, or any combination thereof.

The fractionation column 110 can be made of one or more metallic and/or non-metallic materials physically and chemically compatible with the temperature, pressure, and contents of the fractionation column 110. Suitable metallic materials can include, but are not limited to ferrous alloys including carbon and stainless steels, and non-ferrous alloys such as aluminum, nickel, HASTELLOY®, INCONEL® INCOLOY®, tantalum, and the like.

The rectification section 120 can be empty, partially filled, or completely filled with one or more trays and/or packing. In one or more embodiments, one or more fluid connections, two are shown 121 and 164, can be disposed in, on, or about the rectification section 120 for the introduction of an external reflux via line 164 to the rectification section 120 and the removal of a first product via line 121 from the rectification section 120, as will be described in greater detail below. Additional details of one example of a fractionating system employing a dividing wall column can be found in U.S. Patent Publication No. 2010/0108487.

The rectification section 120 can be operated at a first temperature (“T₁”), the pre-fractionation section 117 can be operated at a second temperature (“T₂”), the main fractionation section 119 can be operated at a third temperature (“T₃”), and the stripping section 116 can be operated at a fourth temperature (“T₄”). T₁ can be less than T₂, T₂ can be less than T₃, and T₃ can be less than T₄.

During operation, a crude AMS via line 122 can be introduced to the fractionation column 110. For example, the crude AMS via line 122 can be introduced to the pre-fractionation section 117. The components of the crude AMS can be separated according to boiling point or relative volatilities. In the pre-fractionation section 117, lighter components can be directed toward the rectification section 120, while heavier components can be directed toward the stripping section 116. In the rectification section 120, the lighter components can be further separated according to boiling point or relative volatilities. For example, the generally lighter components having boiling temperatures below T₁ can flow toward the first end 111a of the fractionation column 110 and be recovered via the line 121, and the generally heavier components having boiling temperatures above T₁ can flow into the main fractionation section 119 and/or back into the pre-fractionation section 117. As such, light hydrocarbons can be recovered via line 121. The light hydrocarbons recovered via line 121 can include, but are not limited to, one or more hydrocarbons having from 1 to about 4 carbon atoms per molecule.

The light hydrocarbons recovered via line 121, if in vapor phase, can be condensed by cooling within one or more condensers 150. The condenser 150 can receive a flow of coolant via line 152, for example, cooling water. The condenser 150 can be any suitable type of heat exchanger, such as a shell-and-tube, cross-flow, or the like.

The condensed light hydrocarbons can be introduced via line 154 to one or more reflux drums (one shown: 156). The light hydrocarbons that remain vapor in reflux drum 156 can be vented via line 158 and reintroduced to the condenser 150, discharged for use in other processes, and/or otherwise disposed of The liquid portion of the light hydrocarbons in the reflux drum 156 can be discharged therefrom via a line 160. The light hydrocarbons in line 160 can be removed as a distillate via line 162 and/or introduced via a line 161 to a pump 163 as a reflux. The reflux via line 163 can then be reintroduced to the fractionation column 110 via the fluid connection 164 discussed above, to assist control or adjustment of a thermal gradient therein, assist in propelling, directing, or otherwise urging heavier components from the rectification section 120 toward the main fractionation section 119, and/or otherwise improve the efficiency of the system 100.

Returning now to the pre-fractionation section 117, the heavier components of the crude AMS introduced thereto, i.e., those not flowing to the rectification section 120, can flow toward to the stripping section 116. The stripping section 116, operated at T₄, can be, as noted above, greater than the temperature T₂ of the pre-fractionation section 117. As such, at least a portion of the heavier components that flow to the stripping section 116 can be vaporized therein, and re-directed toward the pre-fractionation section 117 and/or the main fractionation section 119. As also noted above, the heavier components from the rectification section 120 can condense and flow into the main fractionation section 119 and thus can generally combine with the vaporized components from the stripping section 116.

One or more side-stream lines 170 can be in fluid communication with the main fractionation section 119 to recover one or more side-streams therefrom. The line 170 can extend from, for example, a point located about ½, about ⅓, about ¼, about ⅕, or less of the length of the fractionation column 110 away from the second end 115b of the dividing wall 115, from the stripping section 116, from the top of the dividing wall 115, or from the rectification section 120. As such, the side-stream line 170 can remove a medium-density hydrocarbon (i.e., generally between the density of the light hydrocarbons removed via line 121 and the heavier hydrocarbons in the stripping section 116) from the main fractionation section 119. For example, the side-stream recovered via line 170 can be substantially a mixture of cumene and AMS, as will be further discussed and described below.

The heavy hydrocarbons remaining in the stripping section 116 can be discharged via a heavy hydrocarbon removal line 180. A portion of the discharged heavy hydrocarbons in line 180 can be directed to a reboiler 182 via line 184. The reboiler 182 can receive a heated medium, e.g., steam, via line 183, and can transfer heat from the heated medium to the discharged heavy hydrocarbon and thus increase the temperature thereof to, for example, approximately T₄. The heated heavy hydrocarbon via line 186 can then be recycled back to the stripping section 116 to provide a controlled heat for the fractionation column 110. Additionally, a second portion of the hydrocarbon in line 180 can be discharged via line 188, bypassing the reboiler 182, and directed out of the system 100 and recovered, processed, and/or combusted to produce steam, and/or otherwise disposed of The reboiler 182 can be configured to provide various power duties.

The crude AMS in line 122 can be at a pressure from a low of about 0.5 kg/cm², about 0.75 kg/cm², about 1.0 kg/cm², or about 1.15 kg/cm² to a high of about 1.25 kg/cm², about 1.35 kg/cm², about 1.5 kg/cm², or about 2.0 kg/cm². The crude AMS in line 122 can be at a temperature from a low of about 20° C., about 30° C., about 30° C., about 40° C. or about 50° C. to a high of about 55° C. about 60° C., about 65° C., about 70° C., or about 80° C. The crude AMS in line 122 can have a cumene concentration from a low of about 50 wt %, about 60 wt %, about 70 wt %, or about 80 wt % to a high of about 85 wt %, about 90 wt %, about 95 wt % cumene. For example, the crude AMS in line 122 can have a cumene concentration of about 75 wt % to about 90 wt %, about 82 wt % to about 87 wt %, about 84 wt % to about 93 wt %, about 77 wt % to about 83 wt %, about 79 wt % to about 89 wt %, about 80 wt % to about 84 wt %, about 83 wt % to about 87 wt %, or about 84 wt % to about 86 wt %. The crude AMS in line 122 can have an AMS concentration from a low about 1 wt %, about 3 wt %, about 5 wt %, about 7 wt %, about 9 wt %, about 12 wt %, or about 15 wt % to a high of about 16 wt %, about 18 wt %, about 20 wt %, about 30 wt %, or about 40 wt %. For example, the crude AMS in line 122 can have an AMS concentration of about 10 wt % to about 25 wt %, about 15 wt % to about 20 wt %, 20 wt % to about 30 wt %, about 13 wt % to about 21 wt %, about 15 wt % to about 19 wt %, about 14 wt % to about 16 wt %, or about 13 wt % to about 17 wt %.

The crude AMS in line 122 can have a concentration of total light components from a low of about 0.01 wt %, about 0.05 wt %, or about 0.1 wt % to a high of about 0.5 wt %, about 1 wt %, or about 1.5 wt %. For example, the crude AMS in line 122 can have a concentration of total light components from about 0.5 wt % to about 1 wt %, about 0.1 wt % to about 0.8 wt %, about 0.3 wt % to about 1.3 wt %, or about 0.6 wt % to about 1.4 wt %. The light components can include all components of the crude AMS having a lower boiling point than cumene and/or AMS and can include, but are not limited to, water, acetone, methanol, ethylbenzene, n-propyibenzne, C9 alkanes, sec-butylbenzene, mesityl oxide, or any mixture thereof. The crude AMS in line 122 can have a concentration of total heavy components from a low of about 0.05 wt %, about 0.1 wt %, or about 0.5 wt % to a high of about 1 wt %, about 1.5 wt %, or about 2 wt %. For example, the crude AMS in line 122 can have a concentration of total heavy components from about 1 wt % to about 1.5 wt %, about 0.7 wt % to about 1.3 wt %, about 1.1 wt % to about 1.4 wt %, or about 0.6 wt % to about 1.3 wt %. The heavy components can include all components of the crude AMS having a higher boiling point than cumene and/or AMS and can include, but are not limited to, sec-butylbenzene, tert-butylbenzene, 2-methylbenzofuran, heavy ketones, or any mixture thereof.

The crude AMS in line 122 can have a concentration of ethylbenzene from a low of about 0.001 wt %, about 0.003 wt %, about 0.005 wt %, about 0.006 wt %, about 0.007 wt %, about 0.008 wt %, or about 0.009 wt % to a high of about 0.01 wt %, about 0.012 wt %, about 0.015 wt %, about 0.02 wt %, or about 0.03 wt %. The crude AMS in line 122 can have a concentration of n-propylbenzene from a low of about 0.001 wt %, about 0.003 wt %, about 0.005 wt %, about 0.006 wt %, about 0.007 wt %, about 0.008 wt %, or about 0.009 wt % to a high of about 0.01 wt %, about 0.012 wt %, about 0.015 wt %, about 0.02 wt %, or about 0.03 wt %. The crude AMS in line 122 can have a concentration of sec-butylbenzene from a low of about 0.01 wt %, about 0.03 wt %, about 0.05 wt %, about 0.06 wt %, about 0.07 wt %, or about 0.08 wt % to a high of about 0.09 wt %, about 0.10 wt %, about 0.15 wt %, about 0.2 wt %, or about 0.30 wt %. The crude AMS in line 122 can have a concentration of tert-butylbenzene from a low of about 0.01 wt %, about 0.015 wt %, about 0.02 wt %, about 0.025 wt %, about 0.03 wt %, or about 0.04 wt % to a high of about 0.05 wt %, about 0.055 wt %, about 0.06 wt %, about 0.07 wt %, or about 0.08 wt %. The crude AMS in line 122 can have a concentration of mesityl-oxide from a low of about 0.1 wt %, about 0.15 wt %, about 0.2 wt %, about 0.22 wt %, about 0.25 wt %, or about 0.3 wt % to a high of about 0.4 wt %, about 0.5 wt %, about 0.6 wt %, about 0.7 wt %, or about 0.8 wt %. The crude AMS in line 122 can have a concentration of 2-methylbenzofuran from a low of about 0.05 wt %, about 0.07 wt %, about 0.08 wt %, about 0.09 wt %, about 0.1 wt %, or about 0.12 wt % to a high of about 0.13 wt %, about 0.15 wt %, about 0.2 wt %, about 0.25 wt %, or about 0.35 wt %.

The light hydrocarbons in line 162 can be at a pressure from a low of about 0.5 kg/cm², about 0.75 kg/cm², about 0.9 kg/cm², or about 1 kg/cm² to a high of about 1.1 kg/cm², about 1.15 kg/cm², about 1.2 kg/cm², or about 1.3 kg/cm². The light hydrocarbons in line 162 can be at a temperature from a low of about 40° C., about 50° C., about 60° C., about 70° C. or about 80° C. to a high of about 85° C., about 90° C., about 100° C., about 110° C., or about 120° C. The light hydrocarbons in line 162 can have a concentration of cumene from a low of about 20 wt %, about 30 wt %, about 40 wt %, or about 43 wt % to a high of about 45 wt %, about 47 wt %, about 50 wt %, or about 55 wt %. The light hydrocarbons in line 162 can have a concentration of AMS from a low of about 0.01 wt %, about 0.03 wt %, about 0.05 wt %, about 0.06 wt %, about 0.07 wt %, or about 0.08 wt % to a high of about 0.09 wt %, about 0.1 wt %, about 0.12 wt %, about 0.13 wt %, or about 0.14 wt %. The light hydrocarbons in line 162 can have a concentration of total light and heavy components from a low of about 45 wt %, about 50 wt %, about 53 wt %, or about 55 wt % to a high of about 57 wt %, about 60 wt %, about 70 wt %, or about 80 wt %.

The light hydrocarbons in line 162 can have a concentration of n-propylbenene from a low of about 0.001 wt %, about 0.002 wt %, about 0.003 wt %, about 0.0035 wt %, about 0.0037 wt %, or about 0.004 wt % to a high of about 0.005 wt %, about 0.006 wt %, about 0.007 wt %, about 0.008 wt %, or about 0.009 wt % of n-propylbenzene. The light hydrocarbons in line 162 can have a concentration of sec-butylbenzene of less than about 0.01 wt %, about 0.005 wt %, about 0.001 wt %, or about 0.0005 wt % of sec-butylbenzene. The light hydrocarbons in line 162 can have a concentration of tert-butylbenzene of less than about 0.01 wt %, about 0.005 wt %, about 0.001 wt %, or about 0.0005 wt % of tert-butylbenzene. The light hydrocarbons in line 162 can have a concentration of mesityl-oxide from a low of about 15 wt %, about 20 wt %, about 25 wt %, about 30 wt %, about 32 wt %, or about 33 wt % to a high of about 34 wt %, about 37 wt %, about 40 wt %, about 45 wt %, or about 50 wt %. The light hydrocarbons feed in line 162 can also have a concentration of 2-methylbenzofuran of less than about 0.01 wt %, about 0.005 wt %, about 0.001 wt %, or about 0.0005 wt %.

The side-stream (i.e., the cumene/AMS) in line 170 can be at a pressure from a low of about 0.70 kg/cm², about 0.80 kg/cm², about 0.90 kg/cm², about 1.00 kg/cm², or about 1.10 kg/cm² to a high of about 1.25 kg/cm², about 1.35 kg/cm², about 1.45 kg/cm², or about 1.55 kg/cm². The side-stream in line 170 can be at a temperature from a low of about 85° C., about 95° C., about 115° C., about 135° C. or about 155° C. to a high of about 165° C., about 175° C., about 185° C., about 195° C., or about 205° C. The side-stream in line 170 can have a concentration of cumene from a low of about 50 wt %, about 60 wt %, about 70 wt %, or about 80 wt % to a high of about 90 wt %, about 95 wt %, about 97 wt %, or about 99 wt %. The side-stream in line 170 can have a concentration of AMS from a low of about 1 wt %, about 5 wt %, about 7.5 wt %, about 10 wt %, about 12.5 wt %, or about 14 wt % to a high of about 15 wt %, about 17.5 wt %, about 20 wt %, about 25 wt %, or about 35 wt %. In one or more embodiments, the sidestream in line 170 can contain at least 80 wt %, at least 81 wt %, at least 82 wt %, at least 83 wt %, at least 84 wt %, or at least 85 wt % cumene and at least 10 wt %, at least 11 wt %, at least 12 wt %, at least 13 wt %, or at least 14 wt % AMS. In at least one specific embodiment, the sidestream can contain at least about 82 wt % cumene and at least about 12 wt % AMS. In at least one other specific embodiment, the sidestream can contain at least about 84 wt % cumene and at least about 13 wt % AMS. In at least one other specific embodiment, the sidestream can contain at least about 85 wt % cumene and at least about 14 wt % AMS.

The side-stream in line 170 can have a concentration of total light and heavy components from a low of about 0.05 wt %, about 0.06 wt %, about 0.07 wt %, about 0.08 wt %, about 0.09 wt %, or about 0.1 wt % to a high of about 0.15 wt %, about 0.19 wt %, about 0.21 wt %, about 0.23 wt %, or about 0.25 wt %. For example, the side-stream in line 170 can have a concentration of total light components from a low of about 0.05 wt %, about 0.065 wt %, about 0.075 wt %, or about 0.085 wt % to a high of about 0.1 wt %, about 0.13 wt %, about 0.17 wt %, or about 0.22 wt % and a concentration of total heavy components from a low of about 0.05 wt %, about 0.07 wt %, about 0.09 wt %, or about 0.11 wt % to a high of about 0.14 wt %, about 0.16 wt %, about 0.18 wt %, about 0.2 wt %, or about 0.22 wt %. In an example, the side-stream can have less than about 0.1 wt % of total light components having a boiling point lower than cumene and AMS, and less than about 0.15 wt % of total heavy components having a boiling point higher than cumene and AMS.

The side-stream in line 170 can have a concentration of n-propylbenzene from a low of about 0.005 wt %, about 0.0075 wt %, about 0.009 wt %, or about 0.01 wt % to a high of about 0.015 wt %, about 0.02 wt %, about 0.025 wt %, about 0.03 wt %, or about 0.035 wt %. The side-stream in line 170 can have a concentration of sec-butylbenzene from a low of about 0.005 wt %, about 0.0075 wt %, about 0.01 wt %, or about 0.012 wt % to a high of about 0.017 wt %, about 0.020 wt %, about 0.025 wt %, about 0.030 wt %, or about 0.035 wt %. The side-stream in line 170 can have a concentration of tert-butylbenzene of less than about 0.005 wt %, about 0.01 wt %, about 0.015 wt %, about 0.020 wt %, or about 0.025 wt % to about 0.035 wt %, about 0.040 wt %, about 0.045 wt %, about 0.050 wt %, about 0.055 wt %, or about 0.06 wt %. The side-stream in line 170 can have a concentration of mesityl-oxide from a low of about 0.0005 wt %, about 0.001 wt %, about 0.0015 wt %, about 0.002 wt %, or about 0.0025 wt % to a high of about 0.003 wt %, about 0.0035 wt %, about 0.004 wt %, about 0.0045 wt %, or about 0.005 wt %. The side-stream in line 170 can have a concentration of 2-methylbenzofuran of less than about 0.01 wt %, about 0.005 wt %, about 0.001 wt %, or about 0.0005 wt %.

In at least one specific example, the side-stream via line 170 can have a cumene concentration of at least 85.38 wt %, at least 85.39 wt %, at least 85.40 wt %, at least 85.41 wt %, at least 85.42 wt %, at least 85.43 wt %, at least 85.45 wt %, at least 85.46 wt %, or at least 85.50 wt %. The cumene/AMS via line 170 can have an AMS concentration of at least 14.43 wt %, at least 14.44 wt %, at least 14.45 wt %, at least 14.46 wt %, at least 14.47 wt %, at least 14.48 wt %, at least 14.49 wt %, or at least 14.50 wt %. The cumene/ams via line 170 can have an ethylbenzene concentration less than 0.005 wt %, a n-propylbenzene concentration less than 0.015 wt %, a sec-butylbenzene concentration less than 0.020 wt %, a tert-butylbenzene concentration less than 0.0340 wt % of, a mesityl-oxide concentration less than 0.0030 wt %, and a 2-methylbenzofuran concentration less than 0.0001 wt %.

In another example, the cumene/AMS via line 170 can have a cumene concentration of at least 85.38 wt %, at least 85.39 wt %, at least 85.4 wt %, at least 85.41 wt %, at least 85.42 wt %, at least 85.43 wt %, at least 85.45 wt %, at least 85.46 wt %, or at least 85.5 wt %. The cumene/AMS via line 170 can have an AMS concentration of at least 14.43 wt %, at least 14.44 wt %, at least 14.45 wt %, at least 14.46 wt %, at least 14.47 wt %, at least 14.48 wt %, at least 14.49 wt %, or at least 14.5 wt %. The AMS/cumene via line 170 can have an ethylbenzene concentration less than 0.005 wt %, a n-propylbenzene concentration less than 0.015 wt % of, a sec-butylbenzene concentration less than 0.016 wt %, a tert-butylbenzene concentration less than 0.0335 wt %, a mesityl-oxide concentration less than 0.0027 wt %, and a 2-methylbenzofuran concentration less than 0.0001 wt %.

In still another example, the cumene/AMS via line 170 can have a cumene concentration of at least 85.38 wt %, at least 85.39 wt %, at least 85.40 wt %, at least 85.41 wt %, at least 85.42 wt %, at least 85.43 wt %, at least 85.45 wt %, at least 85.46 wt %, or at least 85.50 wt %. The cumene/AMS via line 170 can have an AMS concentration of at least 14.43 wt %, at least 14.44 wt %, at least 14.45 wt %, at least 14.46 wt %, at least 14.47 wt %, at least 14.48 wt %, at least 14.49 wt %, or at least 14.50 wt %. The AMS/cumene via line 170 can have an ethylbenzene concentration less than 0.005 wt %, a n-propylbenzene concentration less than 0.015 wt %, a sec-butylbenzene concentration less than 0.014 wt %, a tert-butylbenzene concentration less than 0.0330 wt %, a mesityl-oxide concentration less than 0.0025 wt %, and a 2-methylbenzofuran concentration less than 0.0001 wt %.

The heavy hydrocarbons in line 188 can be at a pressure from a low of about 1 kg/cm², about 1.1 kg/cm², about 1.2 kg/cm², about 1.3 kg/cm², or about 1.4 kg/cm² to a high of about 1.45 kg/cm², about 1.55 kg/cm², about 1.65 kg/cm², or about 1.75 kg/cm². The heavy hydrocarbons in line 188 can be at a temperature from a low of about 120° C., about 130° C., about 140° C., about 150° C. or about 160° C. to a high of about 170° C., about 180° C., about 190° C., about 200° C., or about 210° C. The heavy hydrocarbons in line 188 can have a concentration of cumene from a low of about 0.05 wt %, about 0.1 wt %, about 0.15 wt %, or about 0.2 wt % to a high of about 0.3 wt %, about 0.35 wt %, about 0.4 wt %, about 0.45 wt %, or about 0.5 wt %. The heavy hydrocarbons in line 188 can have a concentration of AMS from a low of about 5 wt %, about 15 wt %, about 25 wt %, about 35 wt %, about 45 wt %, or about 55 wt % to a high of about 65 wt %, about 75 wt %, about 85 wt %, or about 90 wt %. The heavy hydrocarbons in line 188 can have a concentration of total light and heavy components from a low of about 9.5 wt %, about 10 wt %, about 20 wt %, or about 34.7 wt % to a high of about 44.8 wt %, about 60 wt %, about 80 wt %, about 90 wt %, or about 94.95 wt %.

The heavy hydrocarbons via line 188 can have a concentration of ethylbenzene of less than 0.01 wt %, less than 0.005 wt %, less than 0.001 wt %, less than 0.0005 wt %, or less than 0.0001 wt %. The heavy hydrocarbons in line 188 can have a concentration of n-propylbenzene from a low of about 0.0001 wt %, about 0.0003 wt %, about 0.0005 wt %, or about 0.0006 wt % to a high of about 0.0007 wt %, about 0.0008 wt %, about 0.0009 wt %, about 0.001 wt %, or about 0.0015 wt %. The heavy hydrocarbons in line 188 can have a concentration of sec-butylbenzene from a low of about 1.4 wt %, about 1.6 wt %, about 1.8 wt %, about 2 wt %, or about 2.2 wt % to a high of about 2.8 wt %, about 3 wt %, about 3.2 wt %, about 3.4 wt %, about 3.6 wt %, or about 3.8 wt %. The heavy hydrocarbons in line 188 can have a concentration of tert-butylbenzene from a low of about 0.3 wt %, about 0.35 wt %, about 0.4 wt %, about 0.45 wt %, or about 0.5 wt % to a high of about 0.6 wt %, about 0.65 wt %, about 0.7 wtYo, about 0.75 wt %, about 0.8 wt %, or about 0.85 wt %. The heavy hydrocarbons in line 188 can have a concentration of mesityl-oxide of less than 0.001 wt %, less than 0.0005 wt %, or less than 0.0001 wt %. The heavy hydrocarbons via line 188 can have a concentration of 2-methylbenzofuran from a low of about 4.5 wt %, about 5 wt %, about 5.5 wt %, about 6 wt %, or about 6.5 wt % to a high of about 7 wt %, about 7.5 wt %, about 8 wt %, about 8.5 wt %, about 9 wt %, or about 9.5 wt %.

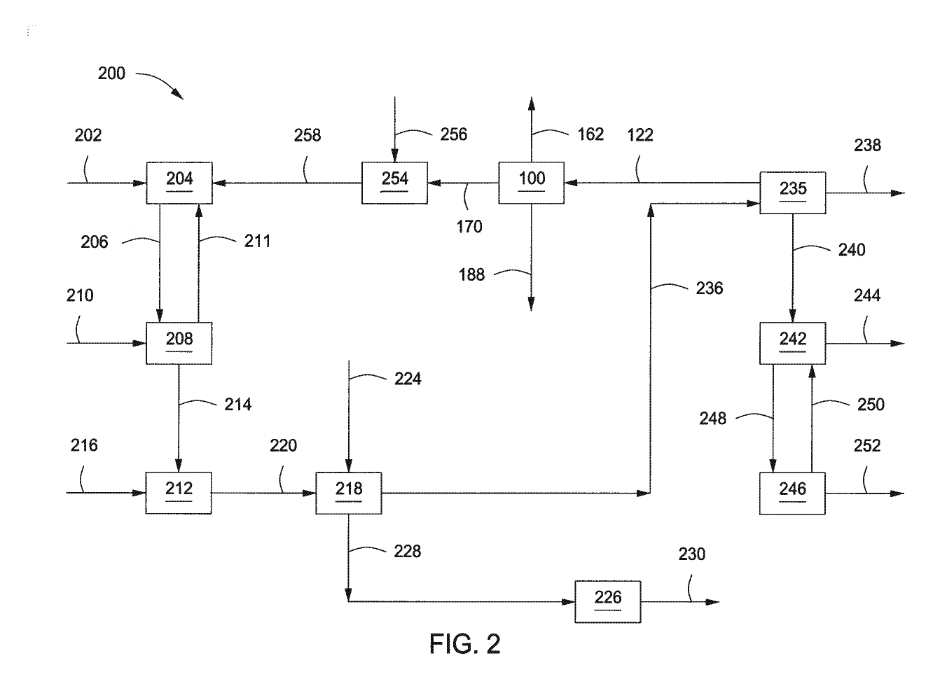

FIG. 2 depicts an illustrative system 200 for producing phenol, according to one or more embodiments. Cumene via line 202 can be introduced to one or more oxidation units 204. The oxidation unit 204 can be any system or device suitable to provide oxygen to the cumene introduced via line 202. For example, the oxidation unit 204 can be one or more (e.g., a cascade) of bubble columns. Air can be added to the bottom of the bubble columns, such that oxygen transfers via the air bubbles into the cumene feed, thereby oxidizing the cumene and forming an oxidized product, which can include CHP, DMBA, and acetophenone (ACP), among other compounds, via line 206. The oxidized product in the line 206 can include from about 10 wt %, about 15 wt %, about 20 wt %, or about 23 wt % to about 25 wt %, about 27 wt %, about 30 wt %, about 35 wt %, or about 40 wt % CHP.

The oxidized product via line 206 can be introduced to one or more concentration units 208 to produce a crude concentrated CHP product via line 214. The concentration unit 208 can be or include one or more vacuum distillation columns, heat exchangers, reflux drums, etc. In such vacuum distillation columns, cumene can be separated at temperatures below about 100° C., for example. Additional cumene can be added via line 210 and introduced as reflux to one or more of the vacuum distillation columns to improve yield performance. Further, such additional cumene can be provided for safety, for example, during shutdowns. After concentration, the cumene can be recycled via line 211 back to the oxidizer 204 to augment the cumene feed introduced via line 202, while the crude concentrated CHP product can be recovered via line 214. The crude concentrated. CHP product in line 214 can include from about 60 wt %, about 70 wt %, or about 80 wt % to about 85 wt %, about 90 wt %, or about 95 wt % of CHP.

The crude concentrated CHP via line 214 can be introduced to one or more cleavage units 212. One or more acids via line 216 can also be introduced to the cleavage unit 212. Suitable acids that can be introduced via line 216 to the cleavage unit 212 can include, but are not limited to, sulfuric acid. The cleavage unit 212 can include a circulation loop (not shown) with one or more heat exchangers included therein. The crude concentrated CHP can be introduced to the circulation loop to produce acetone and phenol. Further, the cleavage reaction can be exothermic, thus the heat exchangers can be provided with cooling water or another heat exchange fluid to control the temperature of the concentrated feed in the cleavage unit 212. In the cleavage unit 212, DMBA can be at least partially dehydrated to AMS, which can react in consecutive reactions with phenol to form cumylphenols. AMS can also form high-boiling point dimers in the cleavage unit 212. DMBA reacts with CHP to form dicumyl peroxide (DCP) and water. Additional byproducts can also be produced, such as hydroxyacetone, 2-methylbenzofurane (2MBF), and diacetone alcohol. These products can be directed to a plug-flow reactor (not shown), for example, at temperatures of about 100° C. or more. In the plug flow reactor, DCP can revert to CHP and DMBA, CHP can be cleaved to phenol and acetone, and DMBA can be dehydrated to AMS and water. At least a portion of these products can be discharged from the cleavage unit 212 as a crude product feed via line 220. One example of a cleavage unit can be as discussed and described in U.S. Pat. No. 5,371,305.

The crude product feed via line 220 can be introduced to one or more neutralization units 218, where a salt solution, for example, sodium phenate, can be introduced via line 224 to reduce, substantially reduce, or terminate any continuing cleavage reactions. At least a portion of the neutralized crude product via line 228 can be introduced to one or more dephenolation units 226. Phenol can be removed or separated from the neutralized crude product within the dephenolation unit 226 using any suitable process. For example, the phenol can be separated via liquid-liquid separation using cumene as an extraction solvent. The recovered phenol can be in the form of sodium phenate, which can be returned to the neutralization unit 218. From the dephenolation unit 226, a waste water can be discharged via line 230 for further processing and/or disposal. Additional hydrocarbons recovered in the dephenolation unit 226 can be directed to the system 100 via line 234.

Returning to the neutralization unit 218, the remaining neutralized crude product, which can include acetone and cumene, can be introduced via line 236 to one or more acetone fractionation units 235. The acetone fractionation unit 235 can be or include one or more distillation columns, e.g., a crude acetone column. In the crude acetone column, acetone can be separated as a top product and/or an upper side-stream via line 238. The acetone via line 238 can be directed back to the cleavage unit 212 (not shown), can be directed to a storage container, or can be otherwise stored or processed for subsequent use. A bottoms product recovered from the crude acetone column can be treated with phenol to remove organic components and/or can be recycled to the neutralization unit 218. The bottoms product from the crude acetone column can be sent to a cumene column, which can also be part of the acetone fractionation unit 235. The cumene, AMS, and some phenol can be separated as top product from the cumene column via line 122 and directed to the system 100. One example of an acetone fractionation unit can be as discussed and described in U.S. Pat. No. 4,340,447.

The remaining feed (i.e., bottoms from the cumene distillation colutnn of the acetone fractionation unit 235) via line 240 can be directed to a phenol fractionation unit 242. The phenol fractionation unit 242 can additionally include one or more heat exchangers (e.g., condensers, reboilers, etc.), reflux barrels, pumps, and the like. The phenol fractionation unit 242 can instead or in addition include one or more adsorption units, purification units, or the like suitable to recover phenol from the hydrocarbon feed in line 240. The phenol fractionation unit 242 can thus recover a phenol product via line 244, which can be directed to a storage container or otherwise processed, purified, conditioned, stored for downstream use. The phenol can, for example, be converted to bis-phenol-A (BPA) to produce polycarbonate and/or phenollic resins.

A remaining heavy hydrocarbon product via line 248 can be directed to one or more heavy removal units 246. The heavy removal unit 246 can be a distillation column, for exatnple, operated at a higher temperature than the phenol fractionation unit 242. Hydrocarbons vaporized in the heavy removal unit 246 can be recycled back to the phenol fractionation unit 242 via line 250, such that additional phenol remaining in the line 248 can be recovered. Remaining heavy hydrocarbons via a line 252 can be removed for further processing, disposal, combustion, etc.

Returning to the acetone fractionation unit 235, top product from the cumene column via line 122 can be directed from the acetone fractionation unit 235 to the fractionation column 110 (FIG. 1). The light hydrocarbon product via line 162 can be recovered, the heavy hydrocarbon product via line 188 can be discharged, and the side-stream mixture of AMS and cumene via line 170 can be recovered, as discussed and described above with reference to FIG. 1. The side-stream mixture of AMS and cumene via line 170 can be directed to one or more hydrogenation units 254 and mixed with hydrogen via a line 256. The hydrogenation unit 254 can include a reactor having one or more selective palladium, nickel, or other catalysts therein. The catalysts, in combination with a flow of hydrogen via line 256, can cause the AMS to hydrogenate to form cumene, without interfering hydrogenation of remaining phenol. Such phenol can then be removed via a cumene scrubber (not shown). The AMS and cumene mixture can thus be converted to a substantially cumene feed, which can be recycled back to the oxidation unit 204 via a line 258. A suitable hydrogenation unit can be as discussed and described in U.S. Pat. No. 7,381,854.

The fractionation column 110 as discussed and described herein can also be used in other applications involving or requiring the separation of cumene and/or AMS. For example, the fractionation column 110 can be incorporated into a process for co-producing AMS and propylene oxide as described in U.S. Pat. Nos. 6,455,712 and 6,984,761.

The fractionation column 110 as discussed and described herein can also be included in applications involving the separation of propylene oxide and cumene. For example, a CHP product and propylene can be subjected to an epoxidation reaction to produce a stream containing cumene, DMBA, propylene, and propylene oxide. The stream containing cumene, DMBA, propylene, and propylene oxide can be introduced to fractionation column 110 to obtain a separated propylene oxide stream, a propylene recycle stream, and a stream containing DMBA and cumene.

### PROPHETIC EXAMPLES

Embodiments of the present invention can be further described with the following prophetic example. Three simulated process configurations (cases) are provided. Case 1 is directed to a conventional system and method of AMS fractionation using two separate fractionation columns: an AMS topping column and an AMS tailing column. Case 2 is directed to a system and method of AMS fractionation in a single, conventional fractionation column that does not include a dividing wall recovering the AMS/cumene mixture with a side-stream. Case 3 is directed to a system and method of AMS fractionation using a dividing wall column, as discussed and described above with regard to FIG. 1.

In Case 1, a crude AMS feed including cumene and AMS, among other compounds, is introduced to the AMS topping column, which includes an overhead heat exchange zone (condenser), a reflux drum, a recycle/reflux to the column, and a reboiler. The bottoms of the AMS topping column is directed to the second AMS tailing fractionation column. The AMS tailing fractionation column likewise includes an overhead heat exchange zone (condenser), a reflux drum, a recycle/reflux to the column, and a reboiler. A light hydrocarbon product is recovered from the top of the AMS topping column, while the bottoms of the AMS topping column is directed to the AMS tailing column, thereby linking the pressure and temperatures of the two columns. The AMS tailing column thus provides for recovery of the AMS and cumene from the top thereof, which can then be sent to a hydrogenation until for conversion to a purer cumene feed. The cumene feed can then be sent to the oxidizer in a cumene-to-phenol system.

In Case 2, a crude AMS feed is introduced to the fractionation column and heated therein. A light hydrocarbon is recovered from the top, with a portion thereof recycled for use as reflux. The bottoms are discharged as heavy hydrocarbons, with a portion being circulated through a reboiler to provide heat to the system. A side-stream line is fluidly coupled to the colutnn between the top and the bottom, for example, above the 48^{th} tray of a 65 tray column (where tray 1 is at the top). The side-stream line removes the cumene and AMS mixture for hydrogenation.

Case 3 is directed to a system and method of AMS fractionation as described above with regard to FIG. 1. Table 1 summarizes the flow rate and mass fractions of the crude AMS stream for all 3 Cases.

TABLE 1

| | Crude AMS feed | |
|---|---|---|
| | Mass Flow Rate (kg/hr) | Mass Fraction (%) |
| Cumene | 7,001.0 | 83.47 |
| Alpha-methylstyrene | 1,262.0 | 15.05 |
| (AMS) | | |
| Others (Light & | 123.1 | 1.48 |
| Heavy Componenets) | | |
| Total Flow (kg/hr) | 8386.1 | 100.00 |

Table 2 summarizes the simulation results of the three cases. The Dual Column System in Case 1 has the highest capital expenditure as it requires two fractionation columns, and energy input requirement. The Single Column System in Case 2 has the lowest capital expenditure, but the purity and recovery of the cumene/AMS product is significantly lower among all the three cases and has the highest reboiler duty' among all three cases, thus illustrating the high operating costs associated with such a design. Accordingly, Case 3, the dividing wall column system, has a similar purity of the Dual Column system, a capital expenditure similar to the Single Fractionation Column, and the lowest energy input requirement than either Case 1 or Case 2. Thus Case 3, the Single AMS Fractionation Column with Dividing Wall, demonstrates the optimum configuration, having a low capital expenditure and low utility costs with a high product recovery and purity.

TABLE 2
Comparison of Three Different AMS Fractionation Column Systems

| | | | | | | Case 3: Single AMS | |
|---|---|---|---|---|---|---|---|
| | | Case 1: Dual AMS | | Case 2: Single AMS | | Fractionation Column | |
| | | Fractionation Columns | | Fractionation Column | | with Dividing Wall | |
| | | Mass Flow | Mass | Mass Flow | Mass | Mass Flow | Mass |
| | | Rate | Fraction | Rate | Fraction | Rate | Fraction |
| | | (kg/hr) | (%) | (kg/hr) | (%) | (kg/hr) | (%) |
| Cumene/AMS | Cumene | 6,967.0 | 85.38 | 6,958.8 | 85.28 | 6,967.3 | 85.38 |
| Product | Alpha- | 1,179.0 | 14.45 | 1,180.1 | 14.46 | 1,178.2 | 14.44 |
| | methylstyrene | | | | | | |
| | (AMS) | | | | | | |
| | Others (Light | 14.0 | 0.16 | 21.1 | 0.26 | 14.5 | 0.18 |
| | & Heavy | | | | | | |
| | Componenets) | | | | | | |
| | Total Flow | 8,160.0 | 100.00 | 8,160.0 | 100.0 | 8,160.0 | 100.00 |
| | (kg/hr) | | | | | | |

| | | | | |
|---|---|---|---|---|
| Reboiler Duty | MW | 3.6 | 4.1 | 3.1 |
| Cumene/AMS Loss | kg/hr | 117.0 | 124.1 | 117.5 |
| Cumeme/AMS | % | 99.84 | 99.74 | 99.82 |
| Product Purity | | | | |

Embodiments of the present disclosure further relate to any one or more of the following paragraphs:

1. A method for fractionating alpha-methylstyrene (AMS), comprising: introducing a crude AMS to a fractionation column, wherein the fractionation column comprises a dividing wall disposed at least partially within the fractionation column such that an internal volume of the fractionation column is divided into at least a pre-fractionation section and a main fractionation section, the pre-fractionation section and the main fractionation section being in fluid communication with one another via a rectification section defined between a first end of the fractionation column and a first end of the dividing wall, a stripping section defined between a second end of the fractionation column and a second end of the dividing wall, or both, and wherein the crude AMS is introduced to the pre-fractionation section of the fractionation column; withdrawing a light hydrocarbon from the fractionation column at or proximal the first end thereof; withdrawing a side-stream from the main fractionation section of the fractionation column; and withdrawing a heavy hydrocarbon from the fractionation column at or proximal the second end thereof.

2. The method according to paragraph 1, wherein the side-stream comprises at least about 84 wt % cumene and at least about 13 wt % AMS.

3. The method according to paragraph 2, wherein the side-stream further comprises less than about 1 wt % of total light components having a boiling point less than cumene and AMS, and less than about 1.5 wt % of total heavy components having a boiling point greater than cumene and AMS.

4. The method according to paragraph 3, wherein the total light components comprise water, acetone, methanol, ethylbenzene, n-propylbenzne, C9 alkanes, sec-butylbenzene, mesityl oxide, or any mixture thereof and the total heavy components comprise sec-butylbenzene, tert-butylbenzene, 2-methylbenzofuran, heavy ketones, or any mixture thereof.

5. The method according to any one of paragraphs 1 to 4, wherein the side-stream is at a temperature of about 140° C. to about 180° C. when withdrawn from the fractionation column.

6. The method according to any one of paragraphs 1 to 5, wherein the crude AMS comprises about 75 wt % to about 90 wt % cutnene and about 10 wt % to about 25 wt % AMS.

7. The method according to paragraph 6, wherein the crude AMS further comprises about 0.5 wt % to about 1 wt % of total light components having a boiling point less than cumene and AMS and about 1 wt % to about 1.5 wt % of total heavy components having a boiling point greater than cumene and AMS.

8. The method according to any one of paragraphs 1 to 7, further comprising: directing a lighter portion of the crude AMS toward the first end of the fractionation column within the pre-fractionation section; directing a heavier portion of the crude AMS toward the second end of the fractionation column within in the pre-fractionation section; and directing at least some of the lighter portion, the heavier portion, or both from the pre-fractionation section past the dividing wall and into the main fractionation section of the fractionation column.

9. A method for fractionating alpha-methylstyrene (AMS), comprising: introducing a crude AMS to a pre-fractionation section defined in a fractionation column; directing a lighter portion of the crude AMS toward a first end of the pre-fractionation section; directing a heavier portion of the crude AMS toward a second end of the pre-fractionation section; directing at least some of the lighter portion, the heavier portion, or both from the pre-fractionation section past a dividing wall disposed within the fractionation column and into a main fractionation section of the fractionation column; and recovering a side-stream via a line fluidly coupled to the main fractionation section between a first end and a second end of the fractionation column.

10. The method according to paragraph 9, wherein the side-stream comprises at least about 82 wt % cumene and at least about 12 wt % AMS.

11. The method according to paragraph 9 or 10, wherein the side-stream comprises at least about 85 wt % cumene and at least about 14 wt % AMS.

12. The method according to paragraph 11, wherein the side-stream further comprises less than about 0.1 wt % of total light components having a boiling point less than cumene and AMS, and less than about 0.15 wt % of total heavy components having a boiling point greater than cumene and AMS.

13. The method according to paragraph 12, wherein the total light components comprise water, acetone, methanol, ethylbenzene, n-propylbenzne, C9 alkanes, sec-butylbenzene, mesityl oxide, or any mixture thereof and the total heavy components comprise sec-butylbenzene, tert-butylbenzene, 2-methylbenzofuran, heavy ketones, or any mixture thereof.

14. The method according to any one of paragraphs 9 to 13, wherein the side-stream feed is at a temperature of about 140° C. to about 180° C. when recovered from the fractionation column.

15. A system for fractionating alpha-methylstyrene (AMS), comprising: a fractionation column; and a dividing wall disposed at least partially within the fractionation column such that an internal volume of the fractionation column is divided into at least a pre-fractionation section and a main fractionation section, the pre-fractionation section and the main fractionation section being in fluid communication with one another via a rectification section defined between a first end of the fractionation column and a first end of the dividing wall, a stripping section defined between a second end of the fractionation column and a second end of the dividing wall, or both; an input line fluidly coupled to the fractionation column and configured to direct a crude AMS to the pre-fractionation section; a light hydrocarbon recovery line fluidly coupled to the fractionation column at or proximal the first end thereof and configured to recover a light hydrocarbon therefrom; a side-stream recovery line fluidly coupled to the fractionation column and configured to recover a cumene/AMS feed from the main fractionation section; and a heavy hydrocarbon removal line fluidly coupled to the fractionation column at or proximal the second end thereof and configured to remove a heavy hydrocarbon therefrom.

16. The system according to paragraph 15, wherein the input line is fluidly coupled to an acetone fractionation unit.

17. The system according to paragraph 15 or 16, wherein the input line is fluidly coupled to a dephenolation unit.

18. The system according to any one of paragraphs 15 to 17, wherein the side-stream recovery line is fluidly coupled to a hydrogenation unit.

19. The system according to anyone of paragraphs 15 to 18, wherein the rectification section is configured to receive a first portion of the crude AMS from the pre-fractionation section, direct a lighter first portion thereof to the light hydrocarbon recovery line and direct a denser first portion thereof to the main fractionation section, and wherein the stripping section is configured to receive a second portion of the crude AMS from the pre-fractionation section, direct a second lighter portion thereof to the main fractionation section, and direct a second heavier portion to the heavy hydrocarbon'removal line,

20. The system according to anyone of paragraphs 15 to 19, further comprising: an oxidation unit configured to receive an oxidant and cumene and to produce an oxidized product comprising cumene hydroperoxide (CHP); a cleavage unit configured to receive the oxidized product and an acid and to produce a crude product; a neutralization unit configured to receive the crude product from the cleavage unit and a salt and to produce a neutralized crude product feed; an acetone distillation unit configured to recover acetone from the neutralized crude product to produce an acetone distillation bottoms and the crude AMS; an AMS hydrogenation unit configured to receive the cutnene/AMS feed via the side-stream recovery line and hydrogen to produce a cumene; and a recycle line configured to recycle at least a portion of the cumene back to the oxidation unit.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for fractionating alpha-methylstyrene (AMS), comprising:
introducing a crude AMS to a fractionation column, wherein the fractionation column comprises a dividing wall disposed at least partially within the fractionation column such that an internal volume of the fractionation column is divided into at least a pre-fractionation section and a main fractionation section, the pre-fractionation section and the main fractionation section being in fluid communication with one another via a rectification section defined between a first end of the fractionation column and a first end of the dividing wall, a stripping section defined between a second end of the fractionation column and a second end of the dividing wall, or both, and wherein the crude AMS is introduced to the pre-fractionation section of the fractionation column;
withdrawing a light hydrocarbon from the fractionation column at or proximal the first end thereof;
withdrawing a side-stream from the main fractionation section of the fractionation column; and
withdrawing a heavy hydrocarbon from the fractionation column at or proximal the second end thereof.

2. The method of claim 1, wherein the side-stream comprises at least about 84 wt % cumene and at least about 13 wt % AMS.

3. The method of claim 2, wherein the side-stream further comprises less than about 1 wt % of total light components having a boiling point less than cumene and AMS, and less than about 1.5 wt % of total heavy components having a boiling point greater than cumene and AMS.

4. The method of claim 3, wherein the total light components comprise water, acetone, methanol, ethylbenzene, n-propylbenzne, C9 alkanes, sec-butylbenzene, mesityl oxide, or any mixture thereof and the total heavy components comprise sechutylbenzene, tert-butylbenzene, 2-methylbenzofuran, heavy ketones, or any mixture thereof.

5. The method of claim 1, wherein the side-stream is at a temperature of about 140° C. to about 180° C. when withdrawn from the fractionation column.

6. The method of claim 1, wherein the crude AMS comprises about 75 wt % to about 90 wt % cumene and about 10 wt % to about 25 wt % AMS.

7. The method of claim 6, wherein the crude AMS further comprises about 0.5 wt % to about 1 wt % of total light components having a boiling point less than cumene and AMS and about 1 wt % to about 1.5 wt % of total heavy components having a boiling point greater than cumene and AMS.

8. The method of claim 1, further comprising:
directing a lighter portion of the crude AMS toward the first end of the fractionation column within the pre-fractionation section;
directing a heavier portion of the crude AMS toward the second end of the fractionation column within in the pre-fractionation section; and
directing at least some of the lighter portion, the heavier portion, or both from the pre-fractionation section past the dividing wall and into the main fractionation section of the fractionation column.

9. A method for fractionating alpha-methylstyrene (AMS), comprising:
introducing a crude AMS to a pre-fractionation section defined in a fractionation column;
directing a lighter portion of the crude AMS toward a first end of the pre-fractionation section;
directing a heavier portion of the crude AMS toward a second end of the pre-fractionation section; directing at least some of the lighter portion, the heavier portion, or both from the pre-fractionation section past a dividing wall disposed within the fractionation column and into a main fractionation section of the fractionation column; and
recovering a side-stream via a line fluidly coupled to the main fractionation section between a first end and a second end of the fractionation column.

10. The method of claim 9, wherein the side-stream comprises at least about 82 wt % cumene and at least about 12 wt % AMS.

11. The method of claim 9, wherein the side-stream comprises at least about 85 wt % cumene and at least about 14 wt % AMS.

12. The method of claim 11, wherein the side-stream further comprises less than about 0.1 wt % of total light components having a boiling point less than cumene and AMS, and less than about 0.15 wt % of total heavy components having a boiling point greater than cumene and AMS.

13. The method of claim 12, wherein the total light components comprise water, acetone, methanol, ethylbenzene, n-propylbenzne, C9 alkanes, sec-butylbenzene, mesityl oxide, or any mixture thereof and the total heavy components comprise sec-butylbenzene, tert-butylbenzene, 2-methylbenzofuran, heavy ketones, or any mixture thereof.

14. The method of claim 9, wherein the side-stream feed is at a temperature of about 140° C. to about 180° C. when recovered from the fractionation column.

15. A system for fractionating alpha-methylstyrene (AMS), comprising:
a fractionation column; and
a dividing wall disposed at least partially within the fractionation column such that an internal volume of the fractionation column is divided into at least a pre-fractionation section and a main fractionation section, the pre-fractionation section and the main fractionation section being in fluid communication with one another via a rectification section defined between a first end of the fractionation column and a first end of the dividing wall, a stripping section defined between a second end of the fractionation column and a second end of the dividing wall, or both;
an input line fluidly coupled to the fractionation column and configured to direct a crude AMS to the pre-fractionation section;
a light hydrocarbon recovery line fluidly coupled to the fractionation column at or proximal the first end thereof and configured to recover a light hydrocarbon therefrom;
a side-stream recovery line fluidly coupled to the fractionation column and configured to recover a cumene/AMS feed from the main fractionation section; and
a heavy hydrocarbon removal line fluidly coupled to the fractionation column at or proximal the second end thereof and configured to remove a heavy hydrocarbon therefrom.

16. The system of claim 15, wherein the input line is fluidly coupled to an acetone fractionation unit.

17. The system of claim 15, wherein the input line is fluidly coupled to a dephenolation unit.

18. The system of claim 15, wherein the side-stream recovery line is fluidly coupled to a hydrogenation unit.

19. The system of claim 15, wherein the rectification section is configured to receive a first portion of the crude AMS from the pre-fractionation section, direct a lighter first portion thereof to the light hydrocarbon recovery line and direct a denser first portion thereof to the main fractionation section, and wherein the stripping section is configured to receive a second portion of the crude AMS from the pre-fractionation section, direct a second lighter portion thereof to the main fractionation section, and direct a second heavier portion to the heavy hydrocarbon removal line.

20. The system of claim 15, further comprising:
an oxidation unit configured to receive an oxidant and cumene and to produce an oxidized product comprising cumene hydroperoxide (CHP);
a cleavage unit configured to receive the oxidized product and an acid and to produce a crude product;
a neutralization unit configured to receive the crude product from the cleavage unit and a salt and to produce a neutralized crude product feed;
an acetone distillation unit configured to recover acetone from the neutralized crude product to produce an acetone distillation bottoms and the crude AMS;
an AMS hydrogenation unit configured to receive the cumene/AMS feed via the side-stream recovery line and hydrogen to produce a cumene; and
a recycle line configured to recycle at least a portion of the cumene back to the oxidation unit.
